(19) United States
(12) Patent Application Publication
(10) Pub. No.: US 2022/0122170 A1
(43) Pub. Date: Apr. 21, 2022

(54) USER CREDIT SCORING METHOD IN DECENTRALIZED IDENTITY SYSTEM AND COMPUTER READABLE STORAGE MEDIUM

(71) Applicant: Xiaonan Du, Beijing (CN)

(72) Inventor: Xiaonan Du, Beijing (CN)

(21) Appl. No.: 17/296,977

(22) PCT Filed: Jan. 21, 2021
(86) PCT No.: PCT/CN2021/073094

§ 371 Date: May 26, 2021

(30) Foreign Application Priority Data
Jul. 21, 2020 (CN) 202010707662.8

(51) Int. Cl. G06Q 40/02; G06F 21/32

(52) U.S. Cl. CPC G06Q 40/025; G06F 21/32

(57) ABSTRACT

A user credit scoring method in a decentralized identity system is provided. The verifiable credential issuer registers with the identity registry based on its own key and business keyword. The credential inspection verifier sets the business keyword information. The identity holder registers with the verifiable credential issuer based on its own key and registration information. The identity holder obtains the verifiable credential from the verifiable credential issuer based on a request of the credential inspection verifier. The identity holder signs the verifiable credential and submits the signed verifiable credential to the credential inspection verifier. The credential inspection verifier verifies the verifiable credential, calculates the credit score of the identity holder, and then evaluates whether the credit score meets the business requirement.—The user credit can be evaluated quickly, accurately and effectively, thus reducing the business risk in the decentralized system.

### TECHNICAL FIELD

The present disclosure relates generally to a Blockchain field, and more particularly relates to a user credit scoring method in a decentralized identity system and a computer readable storage medium.

### BACKGROUND

The traditional digital authentication is centralized, such as domain name and IP address assignment managed by the Internet Corporation for Assigned Names and numbers (ICANN), and digital credential managed by the credential authority (CA) in the public key infrastructure (PKI). The essence of the centralized identity system is that the centralized authority holds the identity data, because the authentication and authorization around the data are also determined by the centralized authority. The identity is not controlled by the user.

In order to solve this problem, many websites has jointly introduced alliance identity, which concept was firstly proposed by Microsoft in 1999. In the alliance identity system, the user's online identity has a certain portability. Nowadays, many websites can support the third-party login, such as Wechat, QQ, Sina microblog, etc.

The decentralization of the identity system is still a big trend. The famous international organizations, such as World Wide Web Consortium (W3C) and Decentralized Identity Foundation (DIF) have also introduced their decentralized identity system standards. How to evaluate user credit quickly, accurately and effectively for reducing the business risk, has become an urgent problem in the decentralized system.

### SUMMARY

The object of the present disclosure is to provide a user credit scoring method in a decentralized identity system and a computer readable storage medium, which is capable of evaluating the user credit quickly, accurately and effectively, thus reducing the business risk in the decentralized system, aiming at the technical problems mentioned in the above prior arts.

In a first aspect, a user credit scoring method in a decentralized identity system is provided, which comprises following steps:

S1. registering with an identity registry based on its own key and business keyword by a verifiable credential issuer;

S2. setting business keyword information by a credential inspection verifier;

S3. registering with the verifiable credential issuer based on its own key and registration information by an identity holder;

S4. extracting a business key data of the identity holder by the verifiable credential issuer when the identity holder carries on a business with the verifiable credential issuer;

S5. obtaining a verifiable credential from the verifiable credential issuer based on a request of the credential inspection verifier by the identity holder;

S6. signing and then submitting the verifiable credential to the credential inspection verifier by the identity holder;

S7. verifying the verifiable credential, calculating a credit score of the identity holder according to the business key data and the business keyword information, and evaluating whether the credit score meets a business requirement, by the credential inspection verifier.

Preferably, the step S1 further comprises following steps:

S11. generating an organization secret key and then an organization public key based on the organization secret key, by the verifiable credential issuer;

S12. generating an organization registration request, signing the organization registration request with the organization secret key, and then sending a signed organization registration request and the business keyword to the identity registry, by the verifiable credential issuer;

S13. verifying the signed organization registration request and generating a decentralized identifier and a decentralized identifier document of the verifiable credential issuer after passing a signature verification, by the identity registry.

Preferably, the step S2 further comprises following steps:

S21. setting the business keyword needed for a credit scoring by the credential inspection verifier;

S22. setting a weight for each business keyword by the credential inspection verifier;

S23. setting an initial credit score by the credential inspection verifier.

Preferably, the step S3 further comprises following steps:

S31. generating an holder secret key and then an holder public key based on the holder secret key, by the identity holder;

S32. generating a holder registration request, signing the holder registration request with the holder secret key, and then sending a signed holder registration request to the verifiable credential issuer, by the identity holder;

S33. verifying the signed holder registration request and then verifying the registration information of the identity holder after passing a signature verification, and then further sending a verification request to the identity registry after passing a registration information verification, by the verifiable credential issuer, wherein the verification request comprises the holder public key;

S34. generating a decentralized identifier and a decentralized identifier document of the identity holder based on the hold public key, and returning the same to the verifiable credential issuer, by the identity registry;

S35. then returning the decentralized identifier and decentralized identifier document of the identity holder to the identity holder by the verifiable credential issuer.

Preferably, the step S4 further comprises following steps:

S41. submitting a starting business request to the verifiable credential issuer by the identity holder;

S42. requesting the decentralized identifier document of the identity holder from the identity registry based on the decentralized identifier of the identity holder, by the verifiable credential issuer;

S43. returning the decentralized identifier document of the identity holder to the verifiable credential issuer, by the identity registry;

S44. verifying the starting business request with the holder public key in the decentralized identifier document of the identity holder, and determining whether to start the business based on a signature verification result, by the verifiable credential issuer;

S45. collecting the business key data of the identity holder by the verifiable credential issuer; wherein the business key data comprises the decentralized identifier of the identity holder, the business keyword, a business amount, a business start time, a business end time and a business normal operation situation.

Preferably, the step S5 further comprises following steps:

S51. sending a business initiation request to the credential inspection verifier by the identity holder, wherein the business initiation request comprises the decentralized identifier and the decentralized identifier document of the identity holder, a signature of the identity holder for the business initiation request and a business requested to be initiated;

S52. returning a verifiable credential information based on the business initiation request by the credential inspection verifier, wherein the verifiable credential information comprises a request of providing a verifiable credential of multiple business keywords;

S53. sending a credential issuance request to the verifiable credential issuer by the identity holder, wherein the credential issuance request comprises the decentralized identifier of the identity holder, a business key word requesting for credit scoring and a signature of the identity holder for the credential issuance request;

S54. verifying the business initiation request based on the holder public key in the decentralized identifier document of the identity holder and issuing a verifiable credential of corresponding business keyword to the identity holder based on a signature verification result, by the verifiable credential issuer.

Preferably, the verifiable credential comprises the decentralized identifier of the verifiable credential issuer issuing the verifiable credential, a signature of the identity holder for the verifiable credential, and a signature of the verifiable credential issuer for the verifiable credential, and the business keyword.

Preferably, the step S6 further comprises following steps:

S61. selecting the verifiable credential of a related business keyword according to the verifiable credential information by the identity holder;

S62. signing selected verifiable credential and submitting a signed verifiable credential to the credential inspection verifier by the identity holder.

Preferably, the step S7 further comprises following steps:

S71. outputting a first verification result according to a match situation between the business keyword in the decentralized identifier document of the verifiable credential issuer and the business keyword in the verifiable credential, by the credential inspection verifier;

S72. obtaining a second verification result through verifying the signature of the verifiable credential issuer for the verifiable credential based on the organization public key in the decentralized identifier document of the verifiable credential issuer, by the credential inspection verifier;

S73. obtaining a third verification result through verifying the signature of the identity holder for the verifiable credential based on the holder public key in the decentralized identifier document of the identity holder, by the credential inspection verifier;

S74. determining whether a whole verification is passed based on the first verification result, the second verification result and the third verification result, if yes, implementing step S75, or else determining that the whole verification fails;

S75. calculating a credit score of the identity holder according to the business key data and the business keyword information, and evaluating whether the credit score meets a business process requirement, by the credential inspection verifier.

Preferably, the step S75 further comprises following steps:

S751. calculating a final credit score based on the initial credit score, the business amount, the weight of the business keyword and the business normal operation situation;

S752. determining whether the business process requirement is satisfied based on the initial credit score and the final credit score.

According to a second aspect, a computer readable storage medium is provided, having stored thereon, a computer program executable by a processor for causing the processor to perform above steps mentioned in the above user credit scoring method in a decentralized identity system.

By implementing the user credit scoring method in a decentralized identity system and a computer readable storage medium according to the present disclosure, the user credit can be evaluated quickly, accurately and effectively, thus reducing the business risk in the decentralized system, through carrying the business keywords when registering by the verifiable credential issuer, setting the business keyword information by a credential inspection verifier, recording the business key data of the identity holder, and calculating the user credit score according to the business keyword information and the business key data. Furthermore, the user's iris or fingerprint can be input as a random seed to generate the holder secret key, such that the identity holder can use the identity information and the Blockchain assets without contact. Furthermore, the present disclosure has further defined the registration process and verification process of the identity holder and the verifiable credential issuer, thus providing a safe and effective method for building the decentralized Blockchain identity.

### BRIEF DESCRIPTION OF THE DRAWINGS

The present disclosure will be further described in combination with the drawings and the embodiments

FIG. 1 is a flow diagram of a user credit scoring method in a decentralized identity system according to a first preferred embodiment of the present disclosure.

FIG. 2 is a flow diagram showing a registration process of a verifiable credential issuer in a user credit scoring method in a decentralized identity system according to a second preferred embodiment of the present disclosure.

FIG. 3 is a flow diagram showing a registration process of an identity holder in a user credit scoring method in a decentralized identity system according to the second preferred embodiment of the present disclosure.

FIG. 4 is a flow diagram showing a recording process of business keyword information in a user credit scoring method in a decentralized identity system according to the second preferred embodiment of the present disclosure.

FIG. 5 is a flow diagram showing verifications of a verifiable credential and a credit score in a user credit scoring method in a decentralized identity system according to the second preferred embodiment of the present disclosure.

### DETAILED DESCRIPTION OF THE PREFERRED EMBODIMENT

In order to make the purpose, technical scheme and advantages of the present disclosure clearer and more obvious, the present disclosure is further described in detail in combination with the attached drawings and embodiments. It should be understood that the specific embodiments described herein are intended to explain the present disclosure only and are not intended to limit the present disclosure.

In the present disclosure, a user credit scoring method in a decentralized identity system is provided. The verifiable credential issuer registers with the identity registry based on its own key and business keyword. The credential inspection verifier sets the business keyword information. The identity holder registers with the verifiable credential issuer based on its own key and registration information. When the identity holder carries on a business with the verifiable credential issuer, the verifiable credential issuer extract a business key data of the identity holder. The identity holder obtains the verifiable credential from the verifiable credential issuer based on a request of the credential inspection verifier. The identity holder signs the verifiable credential and submits the signed verifiable credential to the credential inspection verifier. The credential inspection verifier verifies the verifiable credential, calculates the credit score of the identity holder according to the business key data and the business keyword information, and then evaluates whether the credit score meets the business requirement. By implementing the user credit scoring method in a decentralized identity system and a computer readable storage medium according to the present disclosure, the user credit can be evaluated quickly, accurately and effectively, thus reducing the business risk in the decentralized system.

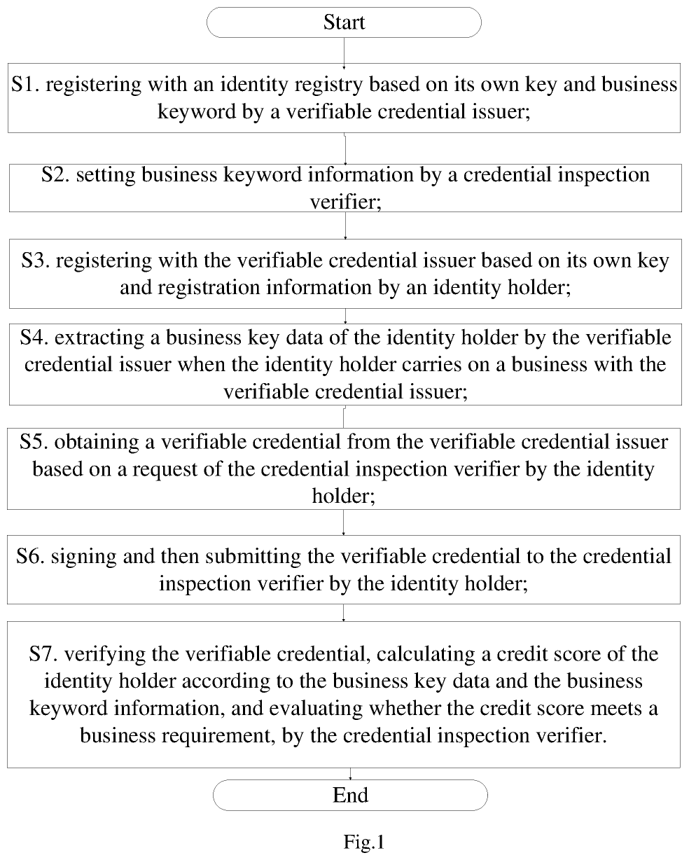

FIG. 1 is a flow diagram of a user credit scoring method in a decentralized identity system according to a first preferred embodiment of the present disclosure. As shown in FIG. 1, in the step S1, the verifiable credential issuer registers with the identity registry based on its own key and business keyword for obtaining the qualification to issue the verifiable credential. For example, the verifiable credential issuer can generate an organization secret key and then generate an organization public key based on the organization secret key. For example, the elliptic curve key system can be used to obtain the organization secret key and organization public key. Of course, any key generation algorithm known in the art can also be adopted. Then, the verifiable credential issuer generates a registration request, signs the registration request with the organization secret key, and then sends the signed registration request and the business keyword to the identity registry. The identity registry verifies the signed registration request and generates a decentralized identifier and a decentralized identifier document of the verifiable credential issuer after passing the signature verification.

In the step S2, the credential inspection verifier sets the business keyword information. For example, the credential inspection verifier sets the business keywords (such as room renting, bike renting, power bank renting, house load, etc.) that needed for the credit scoring, and sets a weight for each business keyword. For example, the house load has the highest weight, the bike renting has a relative lower weight, while the power bank renting has the lowest weight. The credential inspection verifier can set both initial credit score and minimum credit score. For example, if the credit score of the identity holder is lower than the minimum credit score, the identity holder would be rejected directly. The initial credit score can be generated by default for the subsequent calculation of the final credit score.

In the step S3, the identity holder registers with the verifiable credential issuer based on its own key and registration information. In a preferred embodiment of the present disclosure, the identity holder generates the holder secret key and then generates the holder public key based on the holder secret key. For example, the iris of the identity holder can be scanned to generate an iris code. Hash the iris code. The obtained hash value can be used as random seed to generate the holder secret key. Then the holder public key is generated based on the holder secret key. One skilled in the art knows that the iris code can be generated by any iris collector in the related art. For the obtained iris code, the Hash function can be used to calculate for obtaining a character string with a unique fixed length which is then used as a the random seed to generate the holder secret key. Here, the holder secret key can be generated by any known method. The holder public key can also be generated by any known method. For example, the holder public key can be obtained by using the elliptic curve key system, such as R=r*G, in which G refers to the conversion factor between the secret key and public key in the elliptic curve algorithm. Therefore, the holder public key R can be derived from the holder secret key r, but the holder secret key r cannot be derived from the holder public key R, as this is irreversible. For another example, at least one fingerprint of the identity holder can be scanned to generate a fingerprint code. Hash the fingerprint code. The obtained hash value can be used as random seed to generate the holder secret key. Then the holder public key is generated based on the holder secret key. For another example, a plurality of fingerprints of the identity holder can be scanned to generate a plurality of fingerprint codes. Hash each fingerprint code, and each hash value segment is used as a random seed to generate a plurality of holder secret keys. Then multiple holder public keys are generated based on each holder secret key.

Then, the identity holder generates a registration request, signs the registration request with the holder secret key, and then sends the signed registration request to the verifiable credential issuer. The verifiable credential issuer verifies the signed registration request. If the signature verification is passed, the verifiable credential issuer verifies the registration information of the identity holder. If the registration information verification is further passed, the verifiable credential issuer then sends a verification request to the identity registry. The verification request comprises the holder public key. The registration information can be a certain attribute of the identity holder, such as age, asset amount, health status, etc.

Regarding the request of the verifiable credential issuer, the identity registry can generate the decentralized identifier and decentralized identifier document of the identity holder based on the hold public key, and then returning the same to the verifiable credential issuer. Then the verifiable credential issuer returns the decentralized identifier and decentralized identifier document of the identity holder to the identity holder.

In the step S4, when the identity holder carries on a business with the verifiable credential issuer, the verifiable credential issuer extract a business key data of the identity holder. In a preferable embodiment of the present disclosure, the specific extraction process is as follows.

The identity holder can submit a starting business request to the verifiable credential issuer. Preferably, the identity holder can carry his own decentralized identifier and sign the starting business request, and then submit the signed starting business request and the decentralized identifier to the verifiable credential issuer. The verifiable credential issuer can request the decentralized identifier document of the identity holder from the identity registry based on the decentralized identifier of the identity holder. The identity registry returns the decentralized identifier document of the identity holder to the verifiable credential issuer. The verifiable credential issuer can verify the starting business request with the holder public key in the decentralized identifier document of the identity holder, and determines whether to start the business based on the signature verification result. If the signature verification is passed, the business will start, otherwise, the business will be refused. The verifiable credential issuer collects the business key data of the identity holder. The business key data comprises the decentralized identifier of the identity holder, the business keyword, a business amount, a business start time, a business end time and a business normal operation situation. Preferably, each time the identity holder starts a business at the verifiable credential issuer, the verifiable credential issuer would collect the key business data of the identity holder.

Then, when the identity holder needs to carry on a business, it is necessary to pass the verification and the credit score verification of the credential inspection verifier. In step S5, the identity holder obtains the verifiable credential from the verifiable credential issuer based on a request of the credential inspection verifier. Firstly, the identity holder needs to obtain the business key word requesting for the credit scoring through the credential inspection verifier and then find the corresponding verifiable credential issuer, and obtains the verifiable credential from this verifiable credential issuer. The specific process is as follows.

The identity holder sends a business initiation request to the credential inspection verifier. The business initiation request comprises the decentralized identifier and the decentralized identifier document of the identity holder, a signature of the identity holder for the business initiation request and a business requested to be initiated. The credential inspection verifier returns a verifiable credential information based on the business initiation request. The verifiable credential information comprises a request of providing a verifiable credential of multiple business keywords.

The identity holder sends a credential issuance request to the verifiable credential issuer according to the corresponding business keyword. The credential issuance request comprises the decentralized identifier of the identity holder, the business key word requesting for credit scoring and the signature of the identity holder for the credential issuance request. The verifiable credential issuer requests the decentralized identifier document of the identity holder from the identity registry based on the decentralized identifier of the identity holder. The decentralized identifier document of the identity holder comprises the holder public key and the decentralized identifier of the identity holder. The verifiable credential issuer verifies the business initiation request based on the holder public key in the decentralized identifier document of the identity holder. If the signature verification is passed, the verifiable credential of corresponding business keyword is issued to the identity holder. Of course, as mentioned earlier, when multiple holder public keys are included, a verifiable credential can be issued as long as one holder public key has passed the signature verification. Preferably, the verifiable credential comprises the decentralized identifier of the identity holder, the decentralized identifier of the verifiable credential issuer issuing the verifiable credential, the signature of the identity holder for the verifiable credential, and the signature of the verifiable credential issuer for the verifiable credential, and the business keyword, the business amount, the business start time, the business end time and the business normal operation situation.

In the step S6, the identity holder signs the verifiable credential and submits the signed verifiable credential to the credential inspection verifier. Preferably, the identity holder selects the verifiable credential of the related business keyword according to the verifiable credential information, then the identity holder can sign the selected verifiable credential and submit the signed verifiable credential to the credential inspection verifier.

In the step S7, the credential inspection verifier verifies the verifiable credential, calculates the credit score of the identity holder according to the business key data and the business keyword information, and then evaluates whether the credit score meets the business requirement. In a preferable embodiment of the present application, the credential inspection verifier can output a first verification result according to a match situation between the business keyword in the decentralized identifier document of the verifiable credential issuer and the business keyword in the verifiable credential. The credential inspection verifier requests the decentralized identifier document of the verifiable credential issuer according to the decentralized identifier of the verifiable credential issuer in the verifiable credential, and implements a matching operation between the business keyword in the decentralized identifier document and the business keyword to be verified (that is, the business keyword in the verifiable credential information). If the business keywords cannot match with each other, the verification cannot be passed. After passing the verification, the credential inspection verifier verifies the signature of the verifiable credential issuer for the verifiable credential based on the organization public key in the decentralized identifier document of the verifiable credential issuer. If the signature verification is passed, the credential inspection verifier further verifies the signature of the identity holder for the verifiable credential based on the holder public key in the decentralized identifier document of the identity holder. It the signature verification is still passed, implements the credit score calculation step, otherwise, determine that the verification fails.

In the credit score calculation step, the credential inspection verifier calculates the credit score of the identity holder according to the business key data and the business keyword information, and evaluates whether the credit score meets the business process requirement. Preferably, the specific calculation process is as follows. Firstly, the final credit score is calculated based on the initial credit score, the business amount, the weight of the business keyword and the business normal operation situation. Then whether the business process requirement is satisfied, is determined based on the initial credit score and the final credit score. For example, if the initial credit score is less than the final credit score, the business process requirement is satisfied, otherwise, the business process requirement is not satisfied.

By implementing the user credit scoring method in a decentralized identity system, the user credit can be evaluated quickly, accurately and effectively, thus reducing the business risk in the decentralized system. Furthermore, the user's iris or fingerprint can be input as a random seed to generate the holder secret key, such that the identity holder can use the identity information and the Blockchain assets without contact. Furthermore, the present disclosure has further defined the registration process and verification process of the identity holder and the verifiable credential issuer, thus providing a safe and effective method for building the decentralized Blockchain identity.

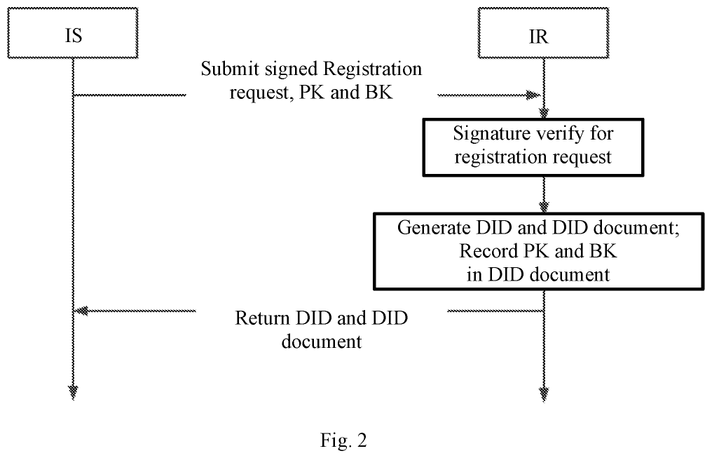

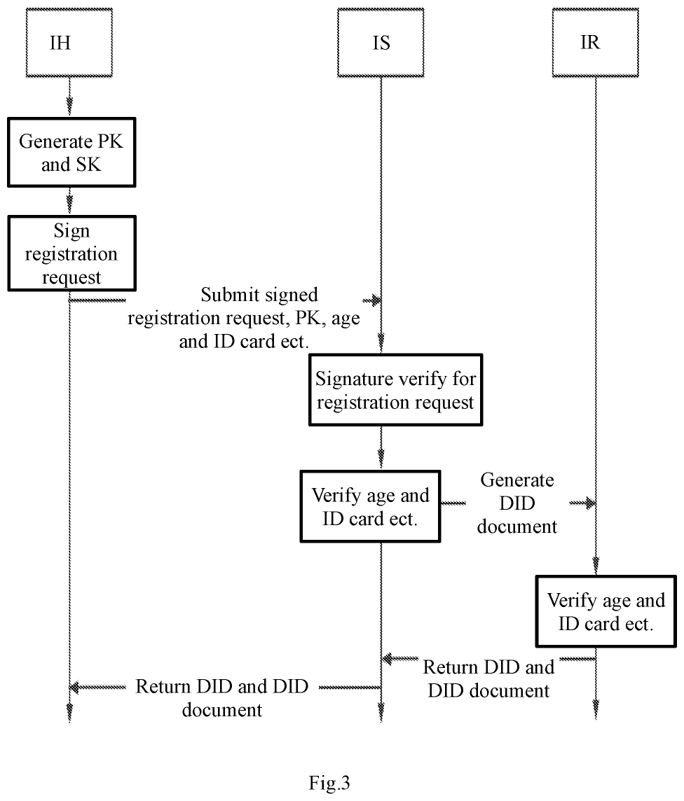

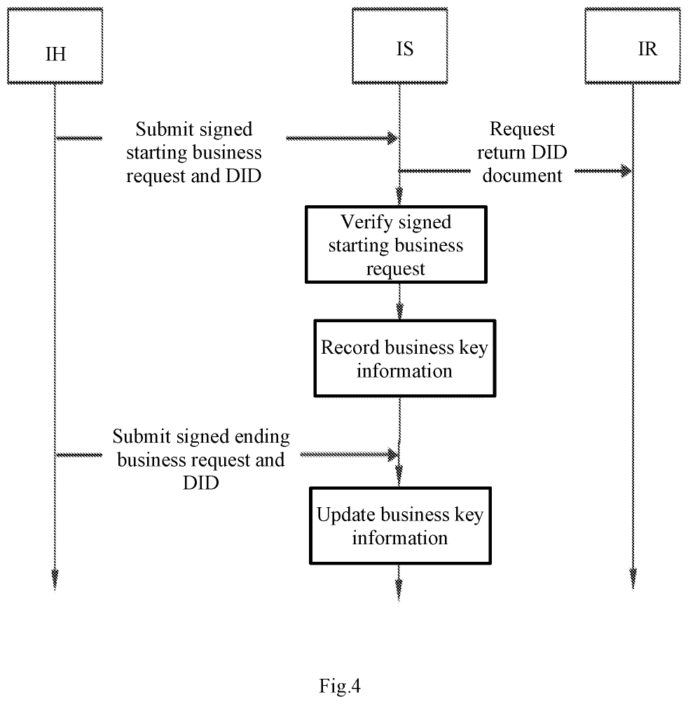

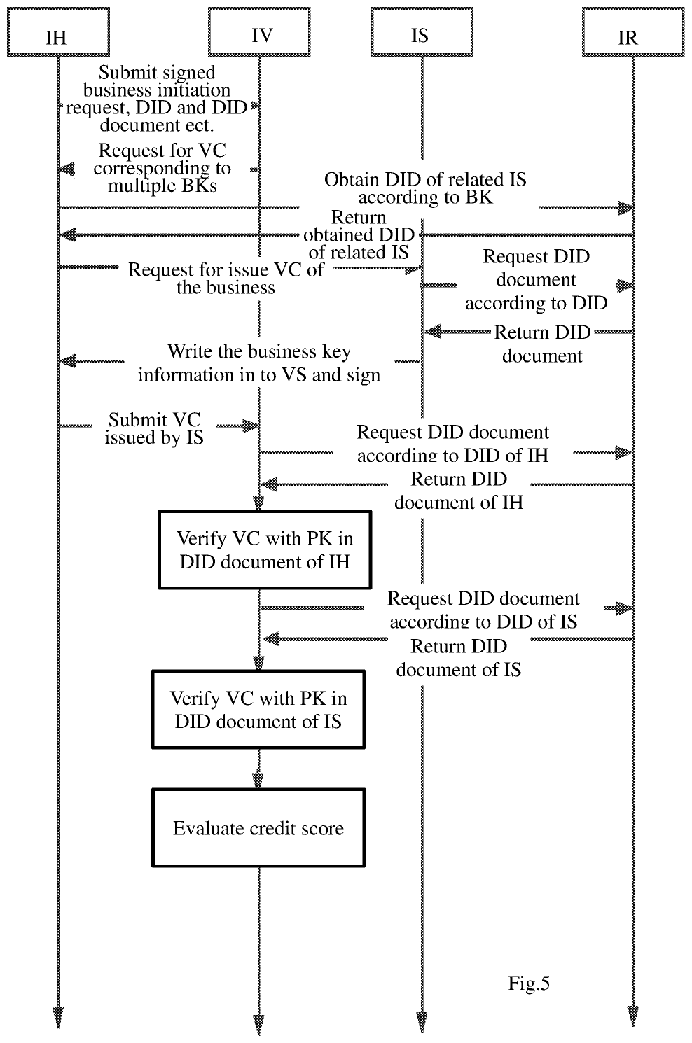

FIG. 2 is a flow diagram showing a registration process of a verifiable credential issuer in a user credit scoring method in a decentralized identity system according to a second preferred embodiment of the present disclosure. FIG. 3 is a flow diagram showing a registration process of an identity holder in a user credit scoring method in a decentralized identity system according to the second preferred embodiment of the present disclosure. FIG. 4 is a flow diagram showing a recording process of business keyword information in a user credit scoring method in a decentralized identity system according to the second preferred embodiment of the present disclosure. FIG. 5 is a flow diagram showing verifications of a verifiable credential and a credit score in a user credit scoring method in a decentralized identity system according to the second preferred embodiment of the present disclosure.

The second preferable embodiment of the present disclosure is explained by combining FIGS. 2-5 as follows. Firstly, the technical terms used in the present disclosure are explained as follows.

Decentralized Identifier (DID)

DID refers to a character string which is similar to URL and can follow the standards formulated by W3C or DIF and other standards organizations, or the standards formulated by multiple alliance organizations. DID records a unique identifiers within multiple alliance organizations and the protocols needed to find the DID. Multiple alliance organizations can locate the entities with the detail DID information according to the DID and request the detail DID information (including the public keys) from the entities.

Decentralized Identifier Document (DID Document)

DID document stores the detail DID information including the DID public key, DID signature type, DID verification type, service type supported by DID, URL supported by DID and so on.

Hash Function (HF)

HF refers to a function with a unique fixed length after calculating the contents on the computer storage medium, which refers to a character string with a unique fixed length generated by the iris or fingerprint.

Secret Key (SK)

SK refers to a key for signing the message communicating between the entities mentioned in the present disclosure to prove the authenticity of the entity identity, and the SK is private and cannot be obtained by others.

Public Key (PK)

PK refers to a key which is public to the entities for verifying the message communicating between the entities.

Identity Holder (IH)

IH refers to the person with a unique identity, and the identity holder needs to generate his own SK and PK by inputting his iris or fingerprint.

Verifiable Credential (VC)

VC comprises information about the credential issuer, information needed to be verified and signature of the credential issuer for the credential and so on.

Verifiable Credential Issuer (IS)

IS refers to a trusted organization that is qualified to issue VC. IS can collect the business key data of IH when carrying business between IS and IH. IS can be a room renting website, a personal credit institution, a bike renting company, a power bank renting company and so on. IS can collect the related data of the IH and submit the collected data when issuing the VC.

Credential Inspection Verifier (IV)

IV refers to an organization that is qualified to conduct a credit evaluation on IH, such as the employer, credit institution, etc. IV can not only verify the identity of IH, but also evaluate the credit score of IH. In the present disclosure, IV obtains the data statistics information of IH recorded in the business between IH and IS from IS, sets the weight for each business keyword, and finally gets the final credit score of IH, and then determines that whether IH can pass the certificate verification according to the final credit score.

Identity Registry (IR)

IR refers to an institution for registering identity, which maintains the database of the DIDs of all entities in the present disclosure, such as the Blockchain and distributed ledger and so on.

Business Keyword (BK)

BK refers to keywords for business used by IS, such as house load, room renting, bike renting, power bank renting, car renting, and so on. One IS can have multiple business keywords, multiple IS can have the same business keyword. The DID document of IS can comprise the business keyword.

IV and IS can query DID document from IR through DID. The corresponding IS can also be found by the business key, and then IS can be requested for providing the information about the business carried on IS corresponding to a certain DID of IH.

In the embodiment shown in FIG. 2, IS registers with IR for obtaining the qualification to issue the VC. The specific registration is as follows.

1. IS firstly generates a SK at first, then generates a PK based on the SK.

2. IS signs a registration request with the SK. At the same time, IS submits the singed registration request together with its own BK to IR.

3. IR verifies the registration request of IS and then generates the DID and DID document of IS after the signature verification is passed.

Then, IV set sets the business keyword information. The specific registration is as follows.

1. IV sets the business keywords those needed for the credit scoring, such as the room renting, bike renting, power bank renting, house load, etc.

2. IV sets a weight for each business keyword.

3. IV sets the minimum credit score. If the credit score of IH is lower than the minimum credit score, the verification would not be passed.

4. IV sets the initial credit score.

In the embodiment shown in FIG. 3, IH registers with IS, and the specific registration is as follows.

1. IH generates its own SK, and then generates its PK based on the SK.

2. IH submits a registration request signed by its SK to IS. IS verifies the signed registration request. If the signature verification is passed, the IS verifies the registration information of IH.

3. If the registration information verification is further passed, the IS then sends a verification request to the IR. The verification request comprises the PK of IH.

4. The IR generates the DID and DID document according to the PK of IH based on the request of IS, and returns the DID document to the IS.

5. IS further returns the DID and DID document to IH.

In the embodiment shown in FIG. 4, IH carries on a business with the IS, and IS extract a business key data of IH. The specific registration is as follows.

1. IH carries on a business with the IS, in which IH signs a starting business request, and submits the signed starting business request together with its DID.

2. IS requests the DID document of IH from IR according to the DID of IH.

3. IR returns the DID document of IH to IS.

4. IS verifies IH with the PK in the DID document of IH, and starts the business after the signature verification is passed, or else the business would be refused.

5. IS collects the business key data which comprises DID of IH, business keyword, business amount, business start time, business end time and business normal operation situation.

6. IS collects the business key data at each time when the IH carries on the business with IS.

In the embodiment shown in FIG. 5, IH request a verification from IV based on its VC. When IH should implement a certain business and the premise of such implementation is that IV should confirm that IH has the qualification to implement the business, namely, whether its credit score meets the requirements. The specific steps are as follows.

1. IH sends a business initiation request to IV. The business initiation request comprises DID and DID document of IH, and the signature of IH for the business request. IV returns the verifiable certificate information, which means the information that requesting IH to submit VC. VC comprises DID of IH, DID of IS which issued the VC, the signature of IS for VC, the signature of IH for VC, the business keyword needed for the credit scoring by IV, the business keyword of IH provided by IS.

2. IH uses the business keyword for the credit scoring requested by IV to find corresponding IS from IR, and then sends the credential issuance request to IS. The credential issuance request comprises DID of IH, the business keyword needed for the credit scoring, the signature of IH for the credential issuance request.

3. IS requests the DID document of IH from IR according to the DID of IH for verifying the signature of IH for the credential issuance request.

4. IR returns DID document of IH. The DID document of IH comprises the DID of IH, and PK of IH. There can be multiple PKs.

5. IS verifies the credential issuance request by the PK in the DID document of IH returned by IR. If the signature verification is passed, IS issues the VC to IH, or else refuses to issue the VC. The VC issued by IS comprises DID of IH, DID of IS, the signature of IH for VC, and the signature of IS for VC, and the business keyword, the business amount, the business start time, the business end time and the business normal operation situation.

6. IH submits the VC with the related business keyword to IV. IV verifies VC and the specific process is as follows.

DID document of IS is requested from IR according to the DID of IS in the VC. The business keyword of DID document of IS is compared with the business keyword in the VC. If the business keywords are not matched with each other, the verification fails.

The signature of IS in VC is verified by the PK of IS. The DID document of IH is requested from IR based on the DID of IH in the VC. The DID document of IH returned by IR comprises all the PKs registered by IH. The signature of IH in the VC is verified by all the PKs returned by IR. The verification is passed as if just one signature verification of PK is passed. Otherwise, the verification fails.

If the signature verifications of IS and IH are both passed, then whether the requirement in the VC satisfies the requirements such as age, asset amount, health status, etc., if yes, the verification is passed, otherwise the verification fails.

After the signature verification is passed, the credit scoring will be started. The credit scoring process is as follows.

The initial credit score is i.

The business amount of each business is recorded as aᵢ.

The weight of the business keyword of each business is wᵢ.

Whether the business operation situation is normal is recorded as f. When the business operation situation is normal, f=1. When there is no business, f=0. When the business operation situation is not normal, f=−1. If one IH never carries a business with the IS, just one business information is returned and f=0.

The final credit score is c, and c=i+Σaᵢ*wᵢ*f.

If c<i, the credit score evaluation fails, while if c≥i, the credit score evaluation is passed,

By implementing the user credit scoring method in a decentralized identity system according to the present disclosure, the user credit can be evaluated quickly, accurately and effectively, thus reducing the business risk in the decentralized system, through carrying the business keywords when registering by the verifiable credential issuer, setting business keyword information by a credential inspection verifier, recording the business key data of the identity holder, and calculating the user credit score according to the business keyword information and the business key data. Furthermore, the user's iris or fingerprint can be input as a random seed to generate the holder secret key, such that the identity holder can use the identity information and the Blockchain assets without contact. Furthermore, the present disclosure has further defined the registration process and verification process of the identity holder and the verifiable credential issuer, thus providing a safe and effective method for building the decentralized Blockchain identity.

According to a second aspect, a computer readable storage medium is provided, having stored thereon, a computer program executable by a processor for causing the processor to perform above steps mentioned in the above user credit scoring method in a decentralized identity system.

Therefore, the application can be realized by hardware, software or combination of software and hardware. The present disclosure may be implemented in a centralized manner in at least one computer system or in a decentralized manner by different parts distributed in several interconnected computer systems. Any computer system or other equipment that can realize the method of the application is applicable. The combination of commonly used software and hardware can be a general-purpose computer system installed with computer programs, and the computer system can be controlled by installing and executing programs to make it run according to the method of the application.

The application can also be implemented through a computer program product, the program contains all the features that can realize the method of the application, and the method of the application can be realized when it is installed in a computer system. The computer program in this document refers to any expression of a set of instructions that can be written in any programming language, code or symbol. The instruction group enables the system to process information to directly realize a specific function, or after one or two of the following steps: a) convert to other languages, codes or symbols; b) reproduce in different formats.

Although the present disclosure is illustrated by specific embodiments, those skilled in the art should understand that various transformations and equivalent substitutions can be made to the disclosure without departing from the scope of the present disclosure. In addition, various modifications can be made to the present disclosure for specific situations or materials without departing from the scope of the disclosure. Therefore, the disclosure is not limited to the specific embodiments disclosed, but should include all the embodiments falling within the scope of the claims of the disclosure.

The above disclosure is just preferable embodiments and does not limit the present disclosure. Any modification, equivalent replacement and improvement made within the spirit and principle of the present disclosure shall be included in the protection scope of the present disclosure.

1. A user credit scoring method in a decentralized identity system comprising following steps:
S1. registering with an identity registry based on its own key and business keyword by a verifiable credential issuer;
S2. setting business keyword information by a credential inspection verifier;
S3. registering with the verifiable credential issuer based on its own key and registration information by an identity holder;
S4. extracting a business key data of the identity holder by the verifiable credential issuer when the identity holder carries on a business with the verifiable credential issuer;
S5. obtaining a verifiable credential from the verifiable credential issuer based on a request of the credential inspection verifier by the identity holder;
S6. signing and then submitting the verifiable credential to the credential inspection verifier by the identity holder;
S7. verifying the verifiable credential, calculating a credit score of the identity holder according to the business key data and the business keyword information, and evaluating whether the credit score meets a business requirement, by the credential inspection verifier.

2. The user credit scoring method in a decentralized identity system according to claim 1, wherein the step S1 further comprises following steps:
S11. generating an organization secret key and then an organization public key based on the organization secret key, by the verifiable credential issuer;
S12. generating an organization registration request, signing the organization registration request with the organization secret key, and then sending a signed organization registration request and the business keyword to the identity registry, by the verifiable credential issuer;
S13. verifying the signed organization registration request and generating a decentralized identifier and a decentralized identifier document of the verifiable credential issuer after passing a signature verification, by the identity registry.

3. The user credit scoring method in a decentralized identity system according to claim 2, wherein the step S2 further comprises following steps:
S21. setting the business keyword needed for a credit scoring by the credential inspection verifier;
S22. setting a weight for each business keyword by the credential inspection verifier;
S23. setting an initial credit score by the credential inspection verifier.

4. The user credit scoring method in a decentralized identity system according to claim 3, wherein the step S3 further comprises following steps:
S31. generating an holder secret key and then an holder public key based on the holder secret key, by the identity holder;
S32. generating a holder registration request, signing the holder registration request with the holder secret key, and then sending a signed holder registration request to the verifiable credential issuer, by the identity holder;
S33. verifying the signed holder registration request and then verifying the registration information of the identity holder after passing a signature verification, and then further sending a verification request to the identity registry after passing a registration information verification, by the verifiable credential issuer, wherein the verification request comprises the holder public key;
S34. generating a decentralized identifier and a decentralized identifier document of the identity holder based on the hold public key, and returning the same to the verifiable credential issuer, by the identity registry;
S35. then returning the decentralized identifier and decentralized identifier document of the identity holder to the identity holder by the verifiable credential issuer.

5. The user credit scoring method in a decentralized identity system according to claim 4, wherein the step S4 further comprises following steps:
S41. submitting a starting business request to the verifiable credential issuer by the identity holder;
S42. requesting the decentralized identifier document of the identity holder from the identity registry based on the decentralized identifier of the identity holder, by the verifiable credential issuer;
S43. returning the decentralized identifier document of the identity holder to the verifiable credential issuer, by the identity registry;
S44. verifying the starting business request with the holder public key in the decentralized identifier document of the identity holder, and determining whether to start the business based on a signature verification result, by the verifiable credential issuer;
S45. collecting the business key data of the identity holder by the verifiable credential issuer; wherein the business key data comprises the decentralized identifier of the identity holder, the business keyword, a business amount, a business start time, a business end time and a business normal operation situation.

6. The user credit scoring method in a decentralized identity system according to claim 5, wherein the step S5 further comprises following steps:
S51. sending a business initiation request to the credential inspection verifier by the identity holder, wherein the business initiation request comprises the decentralized identifier and the decentralized identifier document of the identity holder, a signature of the identity holder for the business initiation request and a business requested to be initiated,
S52. returning a verifiable credential information based on the business initiation request by the credential inspection verifier, wherein the verifiable credential information comprises a request of providing a verifiable credential of multiple business keywords;
S53. sending a credential issuance request to the verifiable credential issuer by the identity holder, wherein the credential issuance request comprises the decentralized identifier of the identity holder, a business key word requesting for credit scoring and a signature of the identity holder for the credential issuance request;
S54. verifying the business initiation request based on the holder public key in the decentralized identifier document of the identity holder and issuing a verifiable credential of corresponding business keyword to the identity holder based on a signature verification result, by the verifiable credential issuer.

7. The user credit scoring method in a decentralized identity system according to claim 6, wherein the step S6 further comprises following steps:
S61. selecting the verifiable credential of a related business keyword according to the verifiable credential information by the identity holder;
S62. signing selected verifiable credential and submitting a signed verifiable credential to the credential inspection verifier by the identity holder.

8. The user credit scoring method in a decentralized identity system according to claim 7, wherein the step S7 further comprises following steps:
S71. outputting a first verification result according to a match situation between the business keyword in the decentralized identifier document of the verifiable credential issuer and the business keyword in the verifiable credential, by the credential inspection verifier;
S72. obtaining a second verification result through verifying the signature of the verifiable credential issuer for the verifiable credential based on the organization public key in the decentralized identifier document of the verifiable credential issuer, by the credential inspection verifier;
S73. obtaining a third verification result through verifying the signature of the identity holder for the verifiable credential based on the holder public key in the decentralized identifier document of the identity holder, by the credential inspection verifier;
S74. determining whether a whole verification is passed based on the first verification result, the second verification result and the third verification result, if yes, implementing step S75, or else determining that the whole verification fails;
S75. calculating a credit score of the identity holder according to the business key data and the business keyword information, and evaluating whether the credit score meets a business process requirement, by the credential inspection verifier.

9. The user credit scoring method in a decentralized identity system according to claim 8, wherein the step S75 further comprises following steps:
S751. calculating a final credit score based on the initial credit score, the business amount, the weight of the business keyword and the business normal operation situation;
S752. determining whether the business process requirement is satisfied based on the initial credit score and the final credit score.

10. (canceled)

11. A computer readable storage medium having stored thereon, a computer program executable by a processor for causing the processor to perform following steps:
S1. registering with an identity registry based on its own key and business keyword by a verifiable credential issuer;
S2. setting business keyword information by a credential inspection verifier;
S3. registering with the verifiable credential issuer based on its own key and registration information by an identity holder;
S4. extracting a business key data of the identity holder by the verifiable credential issuer when the identity holder carries on a business with the verifiable credential issuer;
S5. obtaining a verifiable credential from the verifiable credential issuer based on a request of the credential inspection verifier by the identity holder;
S6. signing and then submitting the verifiable credential to the credential inspection verifier by the identity holder;
S7. verifying the verifiable credential, calculating a credit score of the identity holder according to the business key data and the business keyword information, and evaluating whether the credit score meets a business requirement, by the credential inspection verifier.

12. The computer readable storage medium according to claim 11, wherein the step S1 further comprises following steps:
S11. generating an organization secret key and then an organization public key based on the organization secret key, by the verifiable credential issuer;
S12. generating an organization registration request, signing the organization registration request with the organization secret key, and then sending a signed organization registration request and the business keyword to the identity registry, by the verifiable credential issuer;
S13. verifying the signed organization registration request and generating a decentralized identifier and a decentralized identifier document of the verifiable credential issuer after passing a signature verification, by the identity registry.

13. The computer readable storage medium according to claim 12, wherein the step S2 further comprises following steps:
S21. setting the business keyword needed for a credit scoring by the credential inspection verifier;
S22. setting a weight for each business keyword by the credential inspection verifier;
S23. setting an initial credit score by the credential inspection verifier.

14. The computer readable storage medium according to claim 13, wherein the step S3 further comprises following steps:
S31. generating an holder secret key and then an holder public key based on the holder secret key, by the identity holder;
S32. generating a holder registration request, signing the holder registration request with the holder secret key, and then sending a signed holder registration request to the verifiable credential issuer, by the identity holder;
S33. verifying the signed holder registration request and then verifying the registration information of the identity holder after passing a signature verification, and then further sending a verification request to the identity registry after passing a registration information verification, by the verifiable credential issuer, wherein the verification request comprises the holder public key;
S34. generating a decentralized identifier and a decentralized identifier document of the identity holder based on the hold public key, and returning the same to the verifiable credential issuer, by the identity registry;
S35. then returning the decentralized identifier and decentralized identifier document of the identity holder to the identity holder by the verifiable credential issuer.

15. The computer readable storage medium according to claim 14, wherein the step S4 further comprises following steps:
S41. submitting a starting business request to the verifiable credential issuer by the identity holder;
S42. requesting the decentralized identifier document of the identity holder from the identity registry based on the decentralized identifier of the identity holder, by the verifiable credential issuer;
S43. returning the decentralized identifier document of the identity holder to the verifiable credential issuer, by the identity registry;
S44. verifying the starting business request with the holder public key in the decentralized identifier document of the identity holder, and determining whether to start the business based on a signature verification result, by the verifiable credential issuer;
S45. collecting the business key data of the identity holder by the verifiable credential issuer;
wherein the business key data comprises the decentralized identifier of the identity holder, the business keyword, a business amount, a business start time, a business end time and a business normal operation situation.

16. The computer readable storage medium according to claim 15, wherein the step S5 further comprises following steps:
S51. sending a business initiation request to the credential inspection verifier by the identity holder, wherein the business initiation request comprises the decentralized identifier and the decentralized identifier document of the identity holder, a signature of the identity holder for the business initiation request and a business requested to be initiated,
S52. returning a verifiable credential information based on the business initiation request by the credential inspection verifier, wherein the verifiable credential information comprises a request of providing a verifiable credential of multiple business keywords;
S53. sending a credential issuance request to the verifiable credential issuer by the identity holder, wherein the credential issuance request comprises the decentralized identifier of the identity holder, a business key word requesting for credit scoring and a signature of the identity holder for the credential issuance request;
S54. verifying the business initiation request based on the holder public key in the decentralized identifier document of the identity holder and issuing a verifiable credential of corresponding business keyword to the identity holder based on a signature verification result, by the verifiable credential issuer.

17. The computer readable storage medium according to claim 16, wherein the step S6 further comprises following steps:
S61. selecting the verifiable credential of a related business keyword according to the verifiable credential information by the identity holder;
S62. signing selected verifiable credential and submitting a signed verifiable credential to the credential inspection verifier by the identity holder.

18. The computer readable storage medium according to claim 17, wherein the step S7 further comprises following steps:
S71. outputting a first verification result according to a match situation between the business keyword in the decentralized identifier document of the verifiable credential issuer and the business keyword in the verifiable credential, by the credential inspection verifier;
S72. obtaining a second verification result through verifying the signature of the verifiable credential issuer for the verifiable credential based on the organization public key in the decentralized identifier document of the verifiable credential issuer, by the credential inspection verifier;
S73. obtaining a third verification result through verifying the signature of the identity holder for the verifiable credential based on the holder public key in the decentralized identifier document of the identity holder, by the credential inspection verifier;
S74. determining whether a whole verification is passed based on the first verification result, the second verification result and the third verification result, if yes, implementing step S75, or else determining that the whole verification fails;
S75. calculating a credit score of the identity holder according to the business key data and the business keyword information, and evaluating whether the credit score meets a business process requirement, by the credential inspection verifier.

19. The computer readable storage medium according to claim 18, wherein the step S75 further comprises following steps:
S751. calculating a final credit score based on the initial credit score, the business amount, the weight of the business keyword and the business normal operation situation;
S752. determining whether the business process requirement is satisfied based on the initial credit score and the final credit score.
